(19) United States
(12) Patent Application Publication
(10) Pub. No.: US 2026/0268191 A1
(43) Pub. Date: Sep. 10, 2026

(54) QUANTUM CIRCUIT APPROXIMATION

(71) Applicant: Classiq Technologies LTD., Tel Aviv (IL)

(72) Inventors: Gilad Kishony, Haifa (IL); Natalia Linkov, Givatayim (IL); Avi Elazari, Hod-Hasharon (IL); Lior Gazit, Tel Aviv (IL); Amir Naveh, Haifa (IL); Yehuda Naveh, Tel Aviv (IL)

(73) Assignee: Classiq Technologies LTD., Tel Aviv (IL)

(21) Appl. No.: 19/560,890

(22) Filed: Mar. 9, 2026

Related U.S. Application Data
(60) Provisional application No. 63/769,462, filed on Mar. 10, 2025.

(51) Int. Cl. G06N 10/20; G06N 10/40

(52) U.S. Cl. CPC G06N 10/20; G06N 10/40

(57) ABSTRACT

A method, apparatus, and non-transitory computer readable medium comprising: obtaining an original quantum circuit comprising a plurality of quantum gates and qubits; selecting a target qubit; determining a set of segments for the target qubit based on 2-qubit gates operating on the target qubit. Further comprising: computing an optimized value of a target function comprising decision variables, each corresponding to a different segment, said computing comprising determining a value assignment for each decision variable; determining, for each segment, based on the value assignment for a corresponding decision variable, whether to perform magnitude approximation; and generating an approximated quantum circuit based on the determining.

### CROSS-REFERENCE TO RELATED APPLICATION

This application takes priority from U.S. Provisional Patent Application No. 63/769,462 filed Mar. 10, 2025, the contents of which are incorporated by reference herein in their entirety.

### TECHNICAL FIELD

The present disclosure relates to quantum computers in general, and a system and method to optimize approximation in a quantum circuit.

### BACKGROUND

Quantum computing is a computational paradigm that is fundamentally different from classic computing. In contrast to classic computing, which utilizes bits, quantum computing utilizes qubits. The qubits have unique features, as each qubit can be in superposition, several qubits can be entangled, and all operations on qubits besides measurement, referred to as quantum gates, must be reversible.

### BRIEF SUMMARY

One aspect of the disclosed subject matter is a method comprising: obtaining an original quantum circuit that comprises a plurality of quantum gates and a plurality of qubits; selecting a target qubit from the plurality of qubits; and determining a set of segments for the target qubit, the set of segments is determined based on 2-qubit gates operating on the target qubit. The method further comprises computing an optimized value of a target function, the target function comprises a set of decision variables, each decision variable of the set of decision variables corresponds to a different segment of the set of segments, said computing comprises determining a value assignment for each of the set of decision variables; determining, for each segment of the set of segments, based on the value assignment for a decision variable that corresponds to the each segment, to perform or not perform magnitude approximation; and generating an approximated quantum circuit based on the determining to perform or not perform magnitude approximation for the each segment.

The method wherein diagonal approximation is performed on the each segment where the determination is not to perform magnitude approximation. The method further comprising: executing the approximated quantum circuit on a quantum execution platform. The method wherein said obtaining the original quantum circuit comprises: obtaining an initial quantum circuit; and transforming the initial quantum circuit into the original quantum circuit having a canonical. The transforming the initial quantum circuit is done by: switching an order of gates, combining one or more gates, or decomposing individual gates into multiple gates. The original quantum circuit having a minimal number of gates compared to alternative representation of the initial quantum circuit, wherein the functionality of the initial quantum circuit is maintained.

According to another aspect of the disclosed subject there is a method that also comprises generating for a target segment on which magnitude approximation is determined to be performed by: decomposing one or more rotational gates of the target segment into equivalent sequence of three rotational gates with a rotation axis convenient for commutation of rotation gates through the 2-qubit gates bounding the target segment; applying magnitude approximation to a central rotational gate; and commuting residual rotational gates to adjacent segments of the target segment. The method further comprises consolidating the residual rotational gates.

According to yet another aspect of the disclosed subject there is a method wherein the computation of the optimized value of the target function is performed in a computational complexity that is linear in a number of gates operating on the target qubit. The method wherein the 2-qubit gates operating on the target qubit are generic 2-qubit Clifford gates. The method wherein the generic 2-qubit Clifford gates are C-not (CX) gates. The method wherein universal gate sets in the original quantum circuit are excluded from approximation. The method wherein the original quantum circuit is defined using Clifford+T gate set.

The method further comprises iteratively selecting a different target qubit and determining, for each segment of a set of segments of the different target qubit, to either perform diagonal approximation or magnitude approximation, based on a value assignment for a decision variable that corresponds to the each segment of the different target qubit; and wherein said generating the approximated quantum circuit is based on the determinations made with respect to all qubits of the original quantum circuit.

According to another aspect of the disclosed subject matter there is an apparatus comprising a processor and coupled memory, the processor being adapted to: obtain an original quantum circuit that comprises a plurality of quantum gates and a plurality of qubits; select a target qubit from the plurality of qubits; and determine a set of segments for the target qubit, the set of segments is determined based on 2-qubit gates operating on the target qubit. The processor is further configured to: compute an optimized value of a target function, the target function comprises a set of decision variables, each decision variable of the set of decision variables corresponds to a different segment of the set of segments, said computation determines a value assignment for each of the set of decision variables; determine, for each segment of the set of segments, based on the value assignment for a decision variable that corresponds to the each segment, to perform or not perform magnitude approximation; and generate an approximated quantum circuit based on the determination to perform or not perform magnitude approximation for the each segment.

The apparatus wherein diagonal approximation is performed on the each segment where the determination is not to perform magnitude approximation. The apparatus, wherein the processor is further configured to execute the approximated quantum circuit on a quantum execution platform. The apparatus wherein said the processor is configured to obtain the original quantum circuit by: obtaining an initial quantum circuit; and transforming the initial quantum circuit into the original quantum circuit having a canonical form. The transforming performed by: switching an order of gates, combining one or more gates, or decomposing individual gates into multiple gates. The original quantum circuit is obtained having a minimal number of gates compared to alternative representation of the initial quantum circuit, and the functionality of the initial quantum circuit is maintained.

According to yet another aspect of the disclosed subject matter there is an apparatus wherein the processor is configured to perform the following steps for a target segment on which magnitude approximation is determined to be performed: decompose one or more rotational gates of the target segment into equivalent sequence of three rotational gates with a rotation axis convenient for commutation of rotation gates through the 2-qubit gates bounding the target segment; apply magnitude approximation to a central rotational gate; commute residual rotational gates to adjacent segments of the target segment; and consolidate the residual rotational gates. The apparatus wherein the processor is configured to compute the optimized value of the target function in a computational complexity that is linear in a number of gates operating on the target qubit. The apparatus wherein the 2-qubit gates operating on the target qubit are generic 2-qubit Clifford gates. The apparatus wherein the generic 2-qubit Clifford gates are C-not (CX) gates.

According to an aspect of the disclosed subject matter there is a non-transitory computer readable medium retaining program instructions, which program instructions when read by a processor, cause the processor to perform a method. The method comprising: obtaining an original quantum circuit that comprises a plurality of quantum gates and a plurality of qubits; selecting a target qubit from the plurality of qubits; and determining a set of segments for the target qubit, the set of segments is determined based on 2-qubit gates operating on the target qubit. The method further comprising computing an optimized value of a target function, the target function comprises a set of decision variables, each decision variable of the set of decision variables corresponds to a different segment of the set of segments, said computing comprises determining a value assignment for each of the set of decision variables.

The method also comprising: determining, for each segment of the set of segments, based on the value assignment for a decision variable that corresponds to the each segment, to perform or not perform magnitude approximation; and generating an approximated quantum circuit based on the determining to perform or not perform magnitude approximation for the each segment.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide embodiments or aspects of the disclosure and do not limit the scope of the disclosure. In the drawings:

FIGS. 1A-1C show flowchart diagrams of methods, in accordance with some embodiments of the disclosed subject matter;

FIGS. 2A-2F illustrate schematics of examples of quantum circuits and qubits of equivalence transformations, in accordance with some embodiments of the disclosed subject matter;

FIGS. 3A-3B show schematic illustrations of quantum circuits and qubits, in accordance with some embodiments of the disclosed subject matter; and

FIG. 4 shows a schematic illustration of an environment and architecture in which the disclosed subject matter may be utilized, in accordance with some embodiments of the disclosed subject matter.

### DETAILED DESCRIPTION

One technical problem dealt with by the disclosed subject matter is determining a delegation of magnitude approximation and diagonal approximation in a quantum circuit. Quantum circuits that utilize a finite universal gate set may require gates outside of the gate set to be approximated. The determination of applying approximation may be based on factors such as, the available quantum gates to be utilized, constraints of the quantum execution platform being utilized for executing the quantum circuit, constraints due to utilizing a Quantum Error Correction (QEC) scheme, or the like. In some circumstances magnitude approximation may have shortened sequence length, (e.g. number of gates and depth) than diagonal approximation. This potential reduction in sequence length may reduce quantum resource consumption on a quantum execution platform.

Another technical problem dealt with by the disclosed subject matter is determining when and where magnitude approximation will provide computational efficiency and optimal sequence length over diagonal approximation.

One technical solution provided by the disclosed subject matter includes calculating an optimized value of a target function for multiple segments associated with a target qubit. It is noted that this method provides an independent solution for each qubit, as the determination for each qubit does not affect the other qubits in the quantum circuit. Based on the calculated value a determination of magnitude approximation for each segment may be made.

In some embodiments, an original quantum circuit may be obtained. The original quantum circuit comprises a plurality of quantum gates and a plurality of qubits. A set of segments for a selected target qubit may be determined. In some embodiments, the determination of the set of segments may be based on 2-qubit gates operating on the target qubit. The optimized value of the target function may be calculated. The target function may comprise a set of decision variables, and each decision variable of the set of decision variables may correspond to a different segment of the set of segments. An approximated quantum circuit may be generated.

Another technical solution provided by the disclosed subject matter may be to iteratively select different target qubits of the plurality of qubits to determine, for each one, if a magnitude approximation may be performed, based on the value of a target function that is computed for each target qubit. Additionally, or alternatively a diagonal approximation may be selected when a magnitude approximation is determined not to be performed. In some embodiments, determinations for all qubits of the original quantum circuit may be performed. Based on the determinations, magnitude approximations and/or diagonal approximations may be performed at different segments for different qubits to generate an approximated quantum circuit.

In another technical solution, an initial quantum circuit is obtained and transformed into a canonical form that comprises a minimal number of gates compared to an alternative representation of the initial quantum circuit. The transformation to canonical form may reduce a number of gates by switching an order of gates, merging gates, or the like.

A canonical form of a quantum circuit may be a standardized representation that expresses the circuit according to well-defined rules. The purpose of a canonical form may be to make circuits easier to analyze, compare, optimize, verify by removing redundant structure and ambiguities in how the computation is expressed or the like. Canonical form may be derived by systematically decomposing arbitrary unitary operations into a unique or nearly unique sequence of basic gates, often single-qubit rotations and a minimal set of entangling gates. The canonical form ensures that different circuits implementing the same quantum operation can be recognized as equivalent. This representation may be useful for tasks such as circuit simplification, equivalence checking, hardware compilation, theoretical analysis of quantum algorithms, or the like

One technical effect of utilizing the disclosed subject matter may be to reduce consumption of quantum computing resources. In some embodiments, calculation of the optimized value of the target function may lead to informed determinations of approximation techniques. An identification of which segments of a quantum circuit will utilize less quantum computing resources by utilizing one optimization technique over the other, e.g. magnitude approximation over diagonal approximation, resource savings may be accomplished.

The disclosed subject matter may provide for one or more technical improvements over any preexisting technique and any technique that has previously become routine or conventional in the art. Additional technical problem, solution and effects may be apparent to a person of ordinary skill in the art in view of the present disclosure.

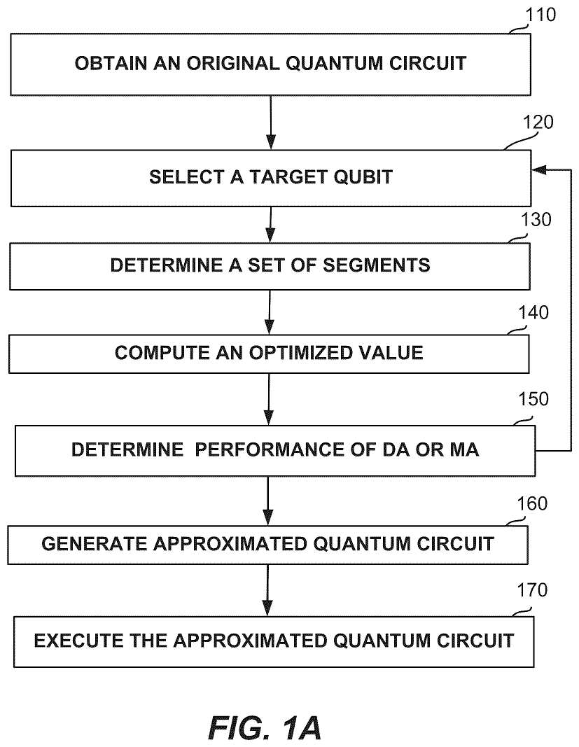

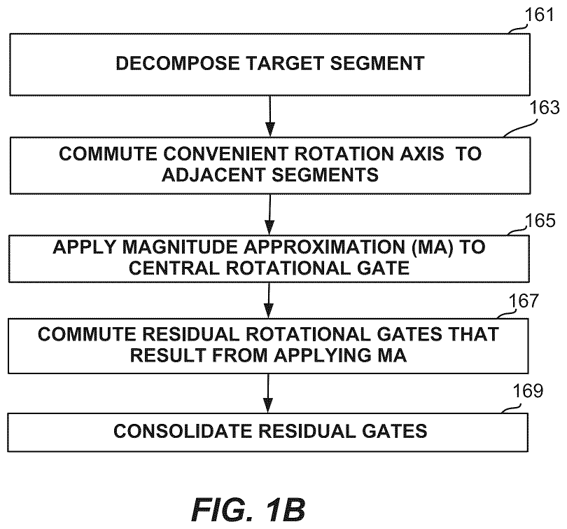

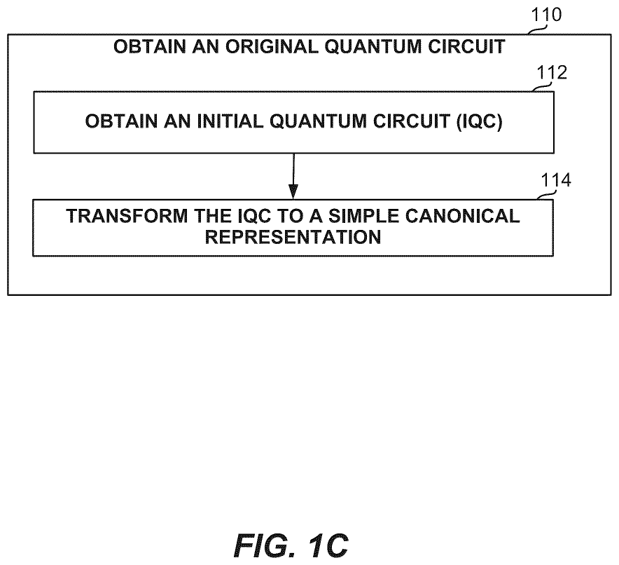

Referring now to FIG. 1A showing a flowchart diagram of a method, in accordance with some embodiments of the disclosed subject matter.

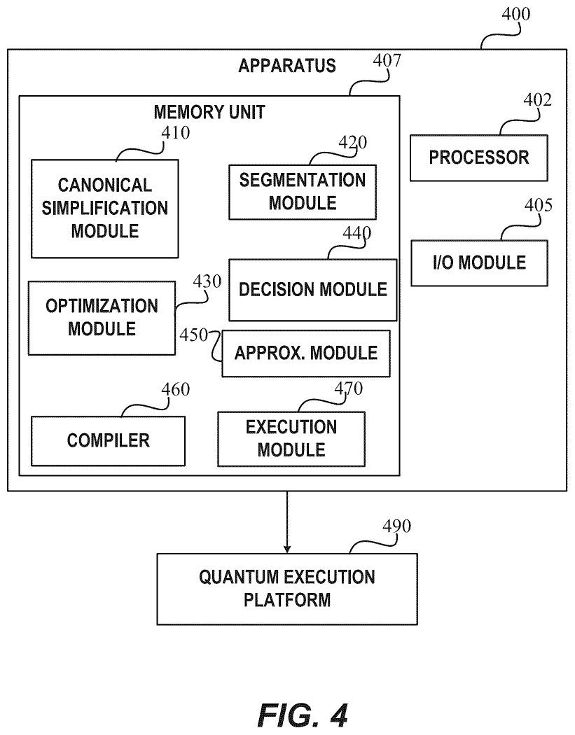

At Step 110, a quantum circuit may be obtained. The quantum circuit may be obtained by an Apparatus 400 of FIG. 4. The quantum circuit may comprise a plurality of qubits and a plurality of gates. In some embodiments, the quantum circuit may define operation of gates on qubits at different cycles.

At Step 120, a target qubit may be selected. In some embodiments, each qubit of the original quantum circuit may be selected and managed utilizing this method separately, without affecting the other qubits in the quantum circuit. Additionally, or alternatively, the selection may be performed iteratively, going through all of the qubits of the original quantum circuit (e.g., performing Steps 120-150 iteratively, each time with respect to a different target qubit).

At Step 130, a set of segments may be determined for the target qubit. In some embodiments, each segment of the set of segments may be determined based on 2-qubit gates operating on the target qubit. In some embodiments, a segment may be defined as all operations performed between either an initial cycle or a first 2-qubit gate and an ending cycle or a second 2-qubit gate. For example, a segment may be bounded by a pair of CNOT gates and may exclude any additional 2-qubit gate other than the bounding CNOT gates. Additionally, or alternatively, segments may comprise rotation(s) that can commute through the 2-qubit gate that separate the segments. This type of rotation(s) may be considered a rotation that is at a segment boundary. In some embodiments, a segment may comprise rotations that are confined in the segment and are not capable of commuting to adjacent segments.

In some embodiments, each segment of the target qubit may represent an opportunity to perform a specific form of approximation. For example, to select between magnitude approximation and between diagonal approximation.

At Step 140, an optimized value of a target function is computed. In some embodiments, the target function comprises a set of decision variables that correspond to each segment of the target qubit. Additionally, or alternatively, the computation comprises determining a value assignment for each decision variable. In some embodiments, the optimization may be performed using linear programming, integer programming, Constraint Optimization Problem (COP) solver, theorem prover, heuristic search engine, or the like. The optimization may be aimed at finding a maximal value of H or a minimal value of H, depending on the way the target function is defined.

In some embodiments, the decision variables may receive either value of 1 representing that magnitude approximation is to be performed or −1, representing that no magnitude approximation be performed. Additionally, or alternatively, when no magnitude approximation should be performed, diagonal approximation may be performed. Such values are arbitrary and exemplary only and are not intended to limit the disclosed subject matter in any way. Other values can be used.

In some embodiments, a target function H operates as a quantum resource usage function that quantifies the total resource expense of approximating rotations within a quantum circuit, enabling determination of optimal approximation strategies for each segment. The equation

$$H = {\sum }_{i} {h}_{i} {σ}_{i} + {\sum }_{i} {J}_{i + \frac{1}{2}} {σ}_{i} {σ}_{i + 1}$$

may comprise two summation terms that together capture both local segment quantum resource usages and interactions between neighboring or adjacent segments. σᵢ is a decision variable associated with segment i.

The first summation term involving

$${J}_{i + \frac{1}{2}} {σ}_{i} {σ}_{i + 1}$$

may capture the interaction between adjacent segments. This term may activate based on the product of adjacent decision variables. When both σᵢ and σᵢ₊₁ equal −1 (both segments use magnitude approximation, or both do not), the product may equal +1. When only one segment uses magnitude approximation, the product behavior may change.

The coefficient

$${J}_{i + \frac{1}{2}}$$

may be defined as

$${J}_{i + \frac{1}{2}} = \frac{3 {r}_{i + \frac{1}{2}} \cdot l - 3 l}{4} \cdot {J}_{i + \frac{1}{2}}$$

may account for rotations at segment boundaries. For example, a rotation that can commute through the 2-qubit gate separating segments may be considered a rotation that is at a segment boundary. A rotation at a segment boundary is defined by i and i+1. The term

$${r}_{i + \frac{1}{2}}$$

is the number of rotations which can move freely from segment i to i+1. In some cases, the term

$${r}_{i + \frac{1}{2}}$$

may receive only the values 0 or 1. The term rᵢ may represent the number of rotations within segment i, excluding rotations that are capable of commuting to adjacent segments (i+1 or i−1). In particular, rᵢ may represent those rotations that are confined within segment i and are not permitted to commute, or otherwise transfer to adjacent segments.

The second summation term involving hᵢσᵢ may represent the local contribution for each individual segment. The coefficient hᵢ may be defined as

$${h}_{i} = ( 2 - \frac{1}{2} ( 3 {r}_{i} ) - \frac{1}{2} ( 3 {r}_{i + \frac{1}{2}} ) ) \cdot l . {h}_{i}$$

may reflect the disadvantage or benefit of applying magnitude approximation to segment i based on the number of rotations it contains.

The term l represents log₂(1/ε), where ε is the approximation precision parameter. The factor of 3l appearing in the expressions may relate to the scaling factor for the number of T gates required in diagonal approximation of single qubit rotations, while the factor of 2l represents the disadvantage contribution when magnitude approximation is applied. By minimizing this H function, the optimization algorithm may determine the optimal configuration of approximation decisions across the entire quantum circuit.

Typically, T gates are quantum gates that perform a rotation around the Z-axis of a Bloch sphere by an angle of π/4, forming part of a Clifford+T gate set. When rotational gates require approximation to conform to a finite universal gate set, the approximation process synthesizes sequences of T gates, with the number of T gates scaling logarithmically with the inverse of the precision parameter log₂(1/ε). In some embodiments, general two-qubit Clifford gates may be treated similarly to CNOT gates. In particular, one may consider how single-qubit rotations can be commuted through Clifford gates. It is noted that the above H function is exemplary only. The above mentioned function H may be the result of the following initial function that is defined based on four terms:

$$H = {\sum }_{i} ( 1 + {σ}_{i} ) \frac{l}{2} + {\sum }_{i} ( 1 - {σ}_{i} ) \frac{3 {r}_{i} l}{2} + {\sum }_{i} ( 1 - {σ}_{i} ) ( 1 - {σ}_{i + 1} ) \frac{3 {r}_{i + \frac{1}{2}} l}{2} + {\sum }_{i} ( ( 1 + {σ}_{i} ) \frac{1}{2} + ( 1 + {σ}_{i + \frac{1}{2}} ) \frac{1}{2} - ( 1 + {σ}_{i} ) ( 1 + {σ}_{i + 1} ) \frac{1}{4} ) 3 l .$$

This function H comprises four terms. The first term represents the cost of the magnitude approximation itself whenever σᵢ equals 1 (e.g., a decision to use magnitude approximation for segment i). The second term is the cost of diagonal approximation of all rotations in the segment which aren't free to move whenever σᵢ equals −1 (e.g., a decision to use diagonal approximation for segment i). The third term turns on when σᵢ and σᵢ₊₁ are both −1, in which case there are

$${r}_{i + \frac{1}{2}}$$

rotations on the boundary to perform diagonal approximation for. The fourth term turns on if at least one of σᵢ and σᵢ₊₁ is 1. In this case, there will be a rotation on the boundary due to the residual of the magnitude approximation (whether there was one to begin with or not). There's a “cost” of 3l for diagonal approximation of this rotation. It is noted that other H functions can be defined and used instead of or in addition to the example provided herein.

At Step 150, a determination is made for each segment of the target qubit to either perform magnitude approximation or not to for each segment. In some embodiments, the determination is based on the value assignment for a decision variable obtained from the target function that corresponds to that segment. Additionally or alternatively, diagonal approximation may be utilized when the determination is not to utilize magnitude approximation.

At Step 160, an approximated quantum circuit is generated based on the determinations to perform either diagonal approximation or magnitude approximation for each segment. In some embodiments, the generation of the approximated quantum circuit is performed by implementing the approximation decisions in the different segments of the target qubit, as determined in Step 150. In some cases, the generation is performed after several qubits were analyzed (e.g., Steps 120-150 were performed for several different qubits), and the generation is performed by implementing the approximations selected for different segments of the different qubits. Additionally, or alternatively, the generation may be performed after implementing equivalence transformations to simplify the resulting quantum circuit.

At Step 170, the approximated quantum circuit may be executed on a quantum execution platform.

Referring now to FIG. 1B showing a flowchart diagram of a method, in accordance with some embodiments of the disclosed subject matter. In some embodiments, the generation of the approximated quantum circuit may comprise further steps. FIG. 1B may exemplify steps performed with respect to segments in which magnitude approximation is performed.

At Step 161, one or more rotational gates of the target segment may be decomposed into an equivalent sequence of three rotational gates with a rotation axis convenient for commutation of rotation gates through the 2-qubit gates bounding the target segment.

At Step 163, the rotational gates with convenient rotation axis may be commuted to adjacent 2-qubit gates bounding the target segment.

At Step 165, magnitude approximation may be applied to a central rotational gate. The magnitude approximation may be performed in canonical form by first reconfiguring all rotations within a target segment into a sequence of three rotational gates with axes convenient for commutation through the 2-qubit gates bounding the segment. The magnitude approximation may then apply to the central rotational gate of the sequence, which may produce an approximating sequence accurate up to residual rotations around axes orthogonal to the central rotation axis on both sides of an approximated rotation.

At Step 167, the magnitude approximation may result in residual rotational gates. In some embodiments, these residual rotational gates may be commuted to adjacent segments through the bounding 2-qubit gates, where they may be absorbed into neighboring rotations.

At Step 169, the residual rotational gates may be consolidated. In some embodiments, the residual rotational gates may then consolidate with existing rotations in the adjacent segments, and diagonal approximation may subsequently be applied to these consolidated rotations. This consolidation of residual gates may be performed before execution on the quantum execution platform to ensure the approximated quantum circuit maintains a desired precision. In some embodiments, the canonical transformation results in the approximated quantum circuit being generated.

Referring now to FIG. 1C showing a flowchart diagram of a method, in accordance with some embodiments of the disclosed subject matter.

FIG. 1C shows potential sub-steps of Step 110.

At Step 112, an Initial Quantum Circuit (IQC) may be obtained. The IQC may be in any alternative logical representation.

At Step 114, the IQC may be transformed to canonical form. The IQC may be transformed by applying equivalence transformations in accordance with well-defined rules, to ensure alternative representations that are equivalent are treated in the same manner. During transformation of the IQC, some gates may be merged with other gates, order of gates may be modified, such as based on commutation properties, or the like. In some embodiments, the transformation may be aimed at merging gates, re-ordering gates, and the like in order to minimize the number of gates without changing the functionality of the IQC. The result of the transformation may be a quantum circuit given in canonical form. The result may be the original quantum circuit obtained in Step 110.

It is noted that in some embodiments, the obtained original quantum circuit may already be provided in canonical form, and no additional simplification thereof may be possible or required.

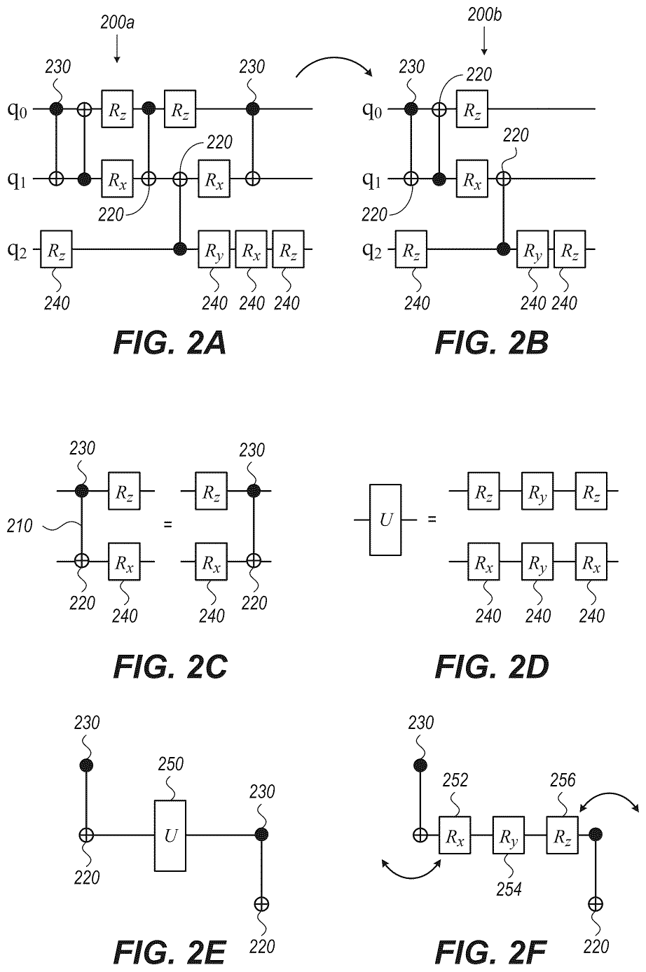

Referring now to FIG. 2A to 2F showing quantum circuits and qubits of equivalence transformations, in accordance with some embodiments of the disclosed subject matter.

FIG. 2A depicts a Sample Quantum Circuit 200a before a canonical equivalence transformation, e.g. simplification and reduction of gates of the canonical form. Once canonical equivalence transformation is performed, a Simple Canonical Form 200b, shown in FIG. 2B, may be obtained.

In some embodiments, Simple Canonical Form 200b of a quantum circuit may be provided by systematically rearranging and consolidating gates operating on each qubit. Additionally, or alternatively, the process may involve identifying Rotational Gates 240 that have the ability to commute with 2-Qubit Gates 210 based on the rotation axis and the position of the rotation relative to the 2-Qubit Gate 210. In some embodiments, 2-Qubit Gates 210 may be CNOT (CX) gates. For example, R_{z} Gates 256 may commute through 2-Qubit Gates 210 (CX gate) when positioned on the Control Gate Qubit 220, while Rₓ Gates 252 may commute through 2-Qubit Gates 210 (CX gate) when positioned on the Target Gate Qubit 230. Additionally, or alternatively, R_{y} Gates 254 may not commute through 2-Qubit Gates 210 (CX gate) in either position. By moving rotational gates according to these commutation relations, rotations around the same axis may be consolidated and merged, potentially reducing the total number of gates in the circuit.

In some embodiments, simplification of the canonical form may be achieved by reconfiguring sequences of rotational gates. Additionally, or alternatively, any sequence of rotation gates may be treated as a single arbitrary single-qubit unitary gate, which may then be decomposed into a sequence of three rotations around different axes, provided no two consecutive axes are the same. This reconfiguration of the quantum circuit may enable rotational gates that would otherwise be unable to commute through a 2-Qubit Gates 210 to be expressed in a form where at least one component rotation can commute. The goal of the simplification process may be to choose a reconfiguration that minimizes the overall number of rotations in the canonical form.

In some embodiments, the 2-qubit gate Control 220 is indicated by filled circles and the 2-qubit gate Target 230 is indicated by a circled plus symbol. Additionally, or alternatively, Simple Canonical Form 200b is a representation of the quantum circuit that comprises a minimal number of gates compared to an alternative canonical representation Canonical Form 200a.

In some embodiments, two consecutive CNOT (CX) gates that operate on the same control qubit and same target qubit may cancel each other out and be removed from the canonical form.

FIG. 2C illustrates an equivalence transformation showing commutation relations between Rotational Gates 240 and 2-Qubit Gates 210. In some embodiments, this representation demonstrates equivalence such that these rotational gates may be moved to either side of the 2-Qubit Gate 210 while maintaining circuit functionality.

Typically, a unitary gate is a quantum gate that performs a reversible transformation on one or more qubits, represented mathematically by a unitary matrix where the matrix multiplied by its conjugate transpose equals the identity matrix. In this disclosure, Unitary Gate 250 may be utilized for canonical form simplification and decomposition operations. As illustrated in FIGS. 2D through 2F, Unitary Gate 250 may be decomposed into a sequence of Rotational Gates 240. Specifically, FIG. 2D shows that a Unitary Gate 250 operating on a qubit may be expressed as an equivalent sequence of three rotational gates around different axes, such as R_{z} 256, R_{y} 254, and Rₓ 252 rotations. FIG. 2E depicts Unitary Gate 250 positioned between two 2-Qubit Gates 210, and FIG. 2F illustrates how this configuration may be decomposed to enable commutation of certain rotational components through the bounding 2-Qubit Gates 210. This decomposition approach supports the canonical simplification process by allowing arbitrary single-qubit unitary operations to be reconfigured in forms that facilitate gate consolidation and reduction of the total gate count in the quantum circuit. Such a decomposition approach can also be used to guide the simplification of the approximated circuit, such as by decomposing the target gate into a sequence of rotation gates, commuting residual rotations gates with CNOT (CX) gates and consolidating sequential rotational gates of the same axis.

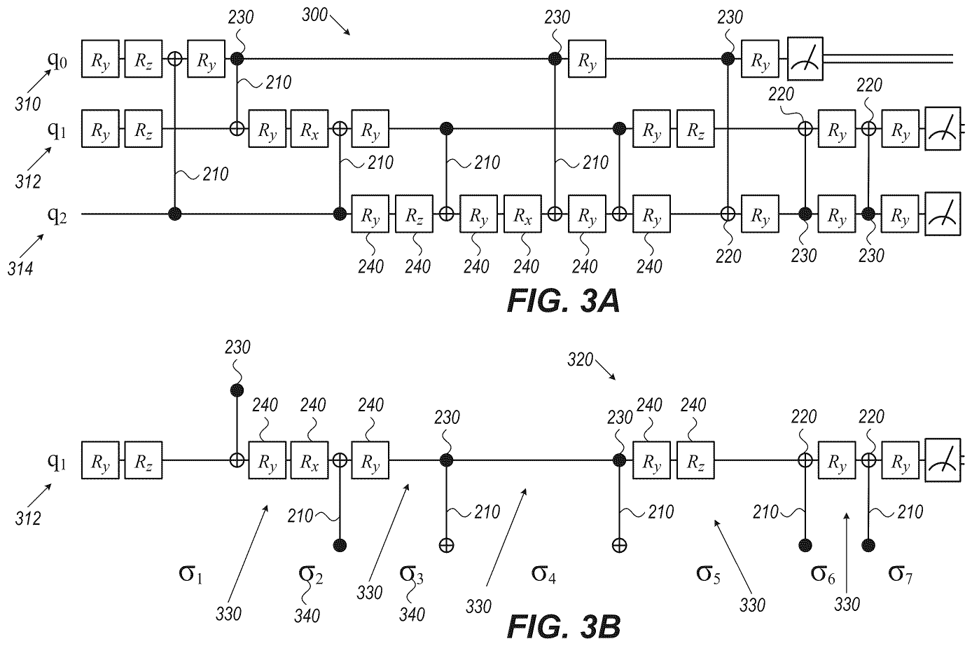

Referring now to FIG. 3A which shows a quantum circuit represented in canonical form, Quantum Circuit 300. In some embodiments, Quantum Circuit 300 may be a simplified quantum circuit. Quantum Circuit 300 may comprise three qubits q₀ 310, q₁ 312 and q₂ 314 illustrated as horizontal lines. In some embodiments, 2-Qubit Gates, such as 210 of FIG. 2C, may appear as vertical connections between any two qubits such as q₀ 310, q₁ 312 and q₂ 314. Additionally, or alternatively, Rotational Gates, such as 240 of FIGS. 2A-2D, may be distributed throughout the circuit.

Referring now to FIG. 3B, as an example, q₁ 312 is selected as a target qubit and is illustrated as being isolated from the Quantum Circuit 300. In some embodiments, Segments 330 are determined based on and bound by the presence of gates manipulating 2-qubits, that is 2-Qubit Gates 210. Additionally, or alternatively, Segments 330 may further comprise at least one Rotational Gate 240 between 2-Qubit Gates 210, or another element on which an approximation decision may be implemented. Additionally, or alternatively, each Segment 330 may correspond to a Decision Variable 340, e.g. σᵢ.

In some embodiments, the decision variables are unknowns within the target function H and may be determined through optimization using an optimization engine, which may be implemented using techniques such as linear programming, COP, or the like. The target function may be constructed from the circuit structure relating to q₁ 312, including segments, rotation counts, and commutation relations. The optimal value assignment for each decision variable may be computed by locating an extremum point (e.g., minimal value/maximal value) of this target function. The decision variables are thus the outputs of the optimization process that locates assignment values that would result with an extremum of the target function. Each decision variable σᵢ corresponds to a segment and may take a value of 1 to indicate that only diagonal approximation is performed in the corresponding segment, or a value of −1 to indicate that magnitude approximation is performed in that segment. The target function His a predefined mathematical expression constructed from circuit parameters.

In some embodiments, the determination of whether to perform magnitude approximation or not for segments of a target qubit may be performed independently from determinations made for other qubits in the quantum circuit. This independence arises because the approximation choice for a specific qubit may not affect the approximation choices available for other qubits in the quantum circuit. The target function H and its associated decision variables σᵢ may operate on a per-qubit basis, where the resource cost function captures only local interactions between adjacent segments within the same qubit. As a result, the optimization problem may be solved separately for each qubit without requiring coordination or information exchange between qubits during the decision-making process. In some embodiments, the disclosed subject matter scales in the number of qubits as the computation complexity is no more than linear in the number of qubits.

In some embodiments, despite the independence of individual qubit decisions, determinations for all qubits of the original quantum circuit may be performed to generate an approximated quantum circuit for the whole original quantum circuit. The optimized approximated quantum circuit represents the complete optimized representation that incorporates the approximation decisions made across all qubits.

While each qubit's optimization may be computed in isolation, the final approximated quantum circuit reflects the aggregate of all these individual determinations. This approach may provide computational efficiency. An analysis of a single qubit could be performed in a liner time in a number of segments on that single qubit. The number of segments may be linear in the number of gates operating on the single qubit. Therefore, the computation complexity in analyzing the single qubit could be linear in the number of gates that operate on the single qubit. In addition, as the analysis is independent of other qubits, the analysis of the entire quantum circuit may be linear in the number of qubits, and for each qubit it may be linear in the number of gates operating on that qubit. Hence, the analysis of the circuit has a complexity that is no more than linear in the number of gates of the circuit and the number of qubits (e.g., O(q·g), where q is the number of qubits and g is the number of gates in the quantum circuit), meaning the optimization process may be performed without requiring significant classical resources during compilation.

Referring now to FIG. 4 showing a block diagram of Apparatus 400, in accordance with some embodiments of the disclosed subject matter.

In some embodiments, Apparatus 400 may comprise one or more Processor(s) 402. Processor 402 may be a Central Processing Unit (CPU), a microprocessor, an electronic circuit, an Integrated Circuit (IC) or the like. Additionally, or alternatively, Processor 402 may be a classical processor, a quantum processor, a hybrid processor, or the like. In this disclosure, “processor” (in the singular) is understood to mean one or more processors that may be hosted on a single computer or distributed over a plurality of networked computers. Processor 402 may be utilized to perform computations required by Apparatus 400 or any of its subcomponents.

In some embodiments of the disclosed subject matter, Apparatus 400 may comprise an Input/Output (I/O) module 405. I/O Module 405 may be utilized to provide an output to and receive input from a user. These I/O items utilizing the I/O module may include, but are not limited to, a display, a keyboard, mouse (both not shown) or the like.

In some embodiments, Apparatus 400 may comprise Memory 407. Memory 407 may be a hard disk drive, a Flash disk, a Random Access Memory (RAM), a memory chip, or the like. In some embodiments, Memory 407 may retain program code operative to cause Processor 402 to perform acts associated with any of the subcomponents of Apparatus 400.

Memory 407 may comprise one or more components as detailed below, implemented as executables, libraries, static libraries, functions, or any other executable components.

In some embodiments, Memory 407 may comprise a Canonical Simplification Module 410. Canonical Simplification Module 410 may be configured to rearrange or reconfigure a quantum circuit, sub-circuits or the like. The reconfiguration may be to transform the quantum circuit into a simplified canonical representation of the quantum circuit. The canonical simplification may be performed at the time of further compiling of a quantum circuit. Additionally, or alternatively, the simplification may be a logical equivalent to an original quantum circuit with a minimal number of gates compared to an alternative representation of the original quantum circuit.

In some embodiments, Memory 407 may comprise Segmentation Module 420. Segmentation Module 420 may be configured to operate on a selected target qubit. In some embodiments, Segmentation Module 420 may be configured to determine segments for the target qubit, such as, for example, based on each segment being bounded by 2-qubit gates and comprising one or more rotational gates positioned between the bounding 2-qubit gates. Segmentation Module 420 may also identify the initial segment (including the initial cycle and bounded by a following 2-qubit gate). Additionally, or alternatively, Segmentation Module 420 may also identify a last segment (including the last cycle and bounded by a 2-qubit gate prior thereto).

In some embodiments, Memory 407 may comprise Optimization Module 430. Optimization Module 430 may be configured to find an assignment to decision variables such that a target function is optimized to its extremum. In some embodiments, the target function may be H. Additionally, or alternatively, the target function is a predefined mathematical expression or formula that quantifies the total resource expense of approximating rotations within a quantum circuit depending on which approximation is applied in each segment.

In some embodiments, Memory 407 may comprise Decision Module 440. Decision Module 440 may be configured to determine which segments will utilize magnitude approximation and which segments will not. This determination may be based on results provided by Optimization Module 430 and specifically based on value assignments of the decision variables determined thereby.

In some embodiments, Memory 407 may comprise Approximation Module 450. Approximation Module 450 may be configured to perform approximation. Approximation Module 450 may be configured to perform the selected approximation technique on a specific segment, such as performing magnitude approximation on segments, performing diagonal approximation on segments, or the like. In some cases, the specific selected approximation for each segment may be determined based on Decision Module 440.

In some embodiments, Memory 407 may comprise Compiler 460. Compiler 460 may be configured to compile or transpile an obtained quantum program or quantum circuit. The compilation may be from a quantum program to a physical or gate level quantum circuit. In some embodiments, Compiler 460 may convert a high-level representation of a quantum program to intermediate logical representations that comprise logical qubits, logical cycles, or the like, and the intermediate logical representations may be converted to a physical or gate level representation. In some embodiments, intermediate logical representations of the quantum program may comprise a graphical representation such as a Directed Acyclic Graph (DAG). In some embodiments, the quantum program may be compiled into an efficient equivalent of itself, considering the characteristics of a target execution platform that will execute the computation.

In some embodiments, Memory 407 may comprise Execution Module 470. Execution Module 470 may be configured to provide an optimized approximated quantum circuit to Quantum Execution Platform 490 to be executed thereon. In some cases, Execution Module 470 may instruct Quantum Execution Platform 490 to execute the optimized approximated quantum circuit.

It is noted that while the disclosed subject matter is described in relation to selecting between magnitude approximation and diagonal approximation, the disclosed subject matter is not limited to only such approximations. The disclosed subject matter may be utilized to select between additional or alternative approximation methods.

As used herein, the term “quantum circuit” means any collection of directives that, when executed on a quantum processor, collectively specify one or more quantum operations, quantum states, evolutions, or measurements, regardless of the directives' format, level of abstraction, or underlying computational paradigm. The term embraces both logical and physical quantum circuits-including representations that precede hardware-specific compilation so long as the directives are ultimately executable or processable by any quantum processor. It encompasses gate-based sequences, measurement-based or cluster-state programs, adiabatic or quantum-annealing schedules, variational-algorithm parameter schedules, pulse-level control waveforms, topological braiding or lattice-surgery scripts, continuous-variable or bosonic-mode instruction sets, analog or Hamiltonian-simulation configurations, quantum-walk or cellular-automaton descriptions, and any future programmatic representation that defines quantum behavior, irrespective of whether it is depicted graphically, textually, or in another machine-readable form. For the avoidance of doubt, a “quantum circuit” does not include source-level quantum programs expressed in high-level programming languages that lack explicit quantum-operation directives, nor purely structural dependency graphs-such as directed-acyclic graphs that describe functional relationships without expressly specifying quantum operations—while logical quantum circuits that specify quantum operations, even if not yet mapped to a specific hardware topology, remain within the scope of the term.

As used herein, “gate” or “quantum gate” denotes any discrete or continuous action—whether logical or physical and whether embodied as a command, pulse, measurement, braiding operation, adiabatic sweep, or other control mechanism—that effects a quantum-state transformation or interaction implemented by a quantum processor, irrespective of the processor's physical platform or computational model.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As used herein, the term “quantum circuit” means any collection of directives that, when executed on a quantum processor, collectively specify one or more quantum operations, quantum states, evolutions, or measurements, regardless of the directives' format, level of abstraction, or underlying computational paradigm. The term embraces both logical and physical quantum circuits-including representations that precede hardware-specific compilation so long as the directives are ultimately executable or processable by any quantum processor. It encompasses gate-based sequences, measurement-based or cluster-state programs, adiabatic or quantum-annealing schedules, variational-algorithm parameter schedules, pulse-level control waveforms, topological braiding or lattice-surgery scripts, continuous-variable or bosonic-mode instruction sets, analog or Hamiltonian-simulation configurations, quantum-walk or cellular-automaton descriptions, and any future programmatic representation that defines quantum behavior, irrespective of whether it is depicted graphically, textually, or in another machine-readable form. For the avoidance of doubt, a “quantum circuit” does not include source-level quantum programs expressed in high-level programming languages that lack explicit quantum-operation directives, nor purely structural dependency graphs-such as directed-acyclic graphs that describe functional relationships without expressly specifying quantum operations—while logical quantum circuits that specify quantum operations, even if not yet mapped to a specific hardware topology, remain within the scope of the term.

As used herein, “gate” or “quantum gate” denotes any discrete or continuous action—whether logical or physical and whether embodied as a command, pulse, measurement, braiding operation, adiabatic sweep, or other control mechanism—that effects a quantum-state transformation or interaction implemented by a quantum processor, irrespective of the processor's physical platform or computational model.

What is claimed is:

1. A method comprising:
obtaining an original quantum circuit that comprises a plurality of quantum gates and a plurality of qubits;
selecting a target qubit from the plurality of qubits;
determining a set of segments for the target qubit, the set of segments is determined based on 2-qubit gates operating on the target qubit;
computing an optimized value of a target function, the target function comprises a set of decision variables, each decision variable of the set of decision variables corresponds to a different segment of the set of segments, said computing comprises determining a value assignment for each of the set of decision variables;
determining, for each segment of the set of segments, based on the value assignment for a decision variable that corresponds to the each segment, to perform or not perform magnitude approximation; and
generating an approximated quantum circuit based on the determining to perform or not perform magnitude approximation for the each segment.

2. The method of claim 1, wherein diagonal approximation is performed on the each segment where the determination is not to perform magnitude approximation.

3. The method of claim 1, further comprising: executing the approximated quantum circuit on a quantum execution platform.

4. The method of claim 1, wherein said obtaining the original quantum circuit comprises:
obtaining an initial quantum circuit; and
transforming the initial quantum circuit into the original quantum circuit having a canonical form by:
switching an order of gates,
combining one or more gates, or
decomposing individual gates into multiple gates;
said original quantum circuit having a minimal number of gates compared to alternative representation of the initial quantum circuit, wherein the functionality of the initial quantum circuit is maintained.

5. The method of claim 1, wherein said generating comprises, for a target segment on which magnitude approximation is determined to be performed:
decomposing one or more rotational gates of the target segment into equivalent sequence of three rotational gates with a rotation axis convenient for commutation of rotation gates through the 2-qubit gates bounding the target segment;
applying magnitude approximation to a central rotational gate;
commuting residual rotational gates to adjacent segments of the target segment; and
consolidating the residual rotational gates.

6. The method of claim 1, wherein said computing the optimized value of the target function is performed in a computational complexity that is linear in a number of gates operating on the target qubit.

7. The method of claim 1, wherein the 2-qubit gates operating on the target qubit are generic 2-qubit Clifford gates.

8. The method of claim 7, wherein the generic 2-qubit Clifford gates are C-not (CX) gates.

9. The method of claim 1, wherein universal gate sets in the original quantum circuit are excluded from approximation.

10. The method of claim 1, wherein the original quantum circuit is defined using Clifford+T gate set.

11. The method of claim 1, further comprises iteratively selecting a different target qubit and determining, for each segment of a set of segments of the different target qubit, to either perform diagonal approximation or magnitude approximation, based on a value assignment for a decision variable that corresponds to the each segment of the different target qubit; and wherein said generating the approximated quantum circuit is based on the determinations made with respect to all qubits of the original quantum circuit.

12. An apparatus comprising a processor and coupled memory, the processor being adapted to:
obtain an original quantum circuit that comprises a plurality of quantum gates and a plurality of qubits;
select a target qubit from the plurality of qubits;
determine a set of segments for the target qubit, the set of segments is determined based on 2-qubit gates operating on the target qubit;
compute an optimized value of a target function, the target function comprises a set of decision variables, each decision variable of the set of decision variables corresponds to a different segment of the set of segments, said computation determines a value assignment for each of the set of decision variables;
determine, for each segment of the set of segments, based on the value assignment for a decision variable that corresponds to the each segment, to perform or not perform magnitude approximation; and
generate an approximated quantum circuit based on the determination to perform or not perform magnitude approximation for the each segment.

13. The apparatus of claim 12, wherein diagonal approximation is performed on the each segment where the determination is not to perform magnitude approximation.

14. The apparatus of claim 12, wherein the processor is further configured to execute the approximated quantum circuit on a quantum execution platform.

15. The apparatus of claim 12, wherein said the processor is configured to obtain the original quantum circuit by:
obtaining an initial quantum circuit; and
transforming the initial quantum circuit into the original quantum circuit having a canonical form by:
switching an order of gates,
combining one or more gates, or
decomposing individual gates into multiple gates;
wherein the original quantum circuit is obtained having a minimal number of gates compared to alternative representation of the initial quantum circuit, and the functionality of the initial quantum circuit is maintained.

16. The apparatus of claim 12, wherein the processor is configured to perform the following steps for a target segment on which magnitude approximation is determined to be performed:
decompose one or more rotational gates of the target segment into equivalent sequence of three rotational gates with a rotation axis convenient for commutation of rotation gates through the 2-qubit gates bounding the target segment;
apply magnitude approximation to a central rotational gate;
commute residual rotational gates to adjacent segments of the target segment; and
consolidate the residual rotational gates.

17. The apparatus of claim 12, wherein the processor is configured to compute the optimized value of the target function in a computational complexity that is linear in a number of gates operating on the target qubit.

18. The apparatus of claim 12, wherein the 2-qubit gates operating on the target qubit are generic 2-qubit Clifford gates.

19. The apparatus of claim 18, wherein the generic 2-qubit Clifford gates are C-not (CX) gates.

20. A non-transitory computer readable medium retaining program instructions, which program instructions when read by a processor, cause the processor to perform a method comprising:
obtaining an original quantum circuit that comprises a plurality of quantum gates and a plurality of qubits;
selecting a target qubit from the plurality of qubits;
determining a set of segments for the target qubit, the set of segments is determined based on 2-qubit gates operating on the target qubit;
computing an optimized value of a target function, the target function comprises a set of decision variables, each decision variable of the set of decision variables corresponds to a different segment of the set of segments, said computing comprises determining a value assignment for each of the set of decision variables;
determining, for each segment of the set of segments, based on the value assignment for a decision variable that corresponds to the each segment, to perform or not perform magnitude approximation; and
generating an approximated quantum circuit based on the determining to perform or not perform magnitude approximation for the each segment.
